(19) United States
(12) Patent Application Publication
(10) Pub. No.: US 2020/0175431 A1
(43) Pub. Date: Jun. 4, 2020

(54) Allocation of Vehicles for Inter-City Rides

(71) Applicant: ANI Technologies Private Limited, Bengaluru (IN)

(72) Inventors: Prerit Srivastava, Gurgaon (IN); Avinash Eratapalli, Bengaluru (IN)

(73) Assignee: ANI Technologies Private Limited

(21) Appl. No.: 16/543,529

(22) Filed: Aug. 17, 2019

(30) Foreign Application Priority Data
Dec. 1, 2018 (IN) 201841045442

(51) Int. Cl. G06Q 10/02; G06Q 30/02; G06Q 50/30; G01C 21/34

(52) U.S. Cl. CPC G06Q 10/02; G01C 21/3438; G06Q 50/30; G06Q 30/0213

(57) ABSTRACT

A method and a system for optimizing inter-city rides are provided. An inter-city booking request for an inter-city ride is received from a passenger device of a passenger for travelling from a first geographical area to a second geographical area. In response to the received inter-city booking request, inter-city demands towards the first geographical area from intermediate geographical areas including the second geographical area are predicted. Based on the predicted inter-city demands and the received inter-city booking request, a discounted ride fare for the inter-city ride is determined. A confirmation corresponding to the discounted ride fare is received from the passenger device of the passenger for the inter-city ride. A vehicle is allocated to the passenger the inter-city ride based on the received confirmation.

### CROSS-RELATED APPLICATIONS

This application claims priority of Indian Application Serial No. 201841045442, filed Dec. 1, 2018, the contents of which are incorporated herein by reference.

### FIELD

Various embodiments of the disclosure relate generally to vehicle allocation systems. More specifically, various embodiments of the disclosure relate to allocation of vehicles to passengers for inter-city rides.

### BACKGROUND

On-demand transportation services are increasingly popular with passengers in the present day due to the convenience of booking transport services easily. Transportation service providers offer varieties of vehicle services to the passengers within a particular city, such as point-to-point rides, shared rides, vehicle rentals, or the like. The transportation service providers also offer inter-city rides to the passengers for travelling from one city to another city. For booking an inter-city ride, a passenger initiates a booking request for the inter-city ride through a mobile application or a website of a transportation service provider. The passenger provides details of the inter-city ride, such as a pick-up location in a first city, a drop-off location in a second city, and a pick-up time. The transportation service provider computes a fare for the inter-city ride and provides the passenger an option to confirm the booking for the inter-city ride based on the computed fare. If the booking is confirmed, the transportation service provider allocates a vehicle to the passenger.

Generally, the vehicle is allocated to the passenger for a one-way trip for travelling from the first city to the second city. As the vehicle and a driver of the vehicle are associated with the first city, the driver must drive back the vehicle to the first city from the second city after completing the ride associated with the booking request. However, the transportation service provider does not allocate the vehicle to any inter-city ride beforehand for a return trip from the second city to the first city. Most of the time, the vehicle returns empty to the first city without completing any booking requests during the return trip. Thus, the transportation service provider is imposed to include the cost of the return trip in the fare for the inter-city ride including cost of the driver's services and the fuel consumed during the return ride. Effectively, the fare for the inter-city ride may be doubled for the passenger. This discourages the passengers from making future bookings for inter-city rides with the transportation service provider, thus reducing demand for inter-city rides.

In light of the foregoing, there exists a need for an inter-city ride optimization method and system for optimizing allocation of a vehicle to an inter-city ride such that the fare for the inter-city ride is reduced and passengers are offered with attractive prices for booking inter-city rides, thus increasing both the demand and a number of bookings for inter-city rides for the transportation service provider.

### SUMMARY

Various embodiments of the present disclosure provide a method and a system for optimizing inter-city rides in a ride-hailing industry. The method includes one or more operations that are executed by a transportation server of the system to receive an inter-city booking request from a passenger device of a passenger. The inter-city booking request is a request for booking a vehicle service for a first ride, which is an inter-city ride from a first geographical area to a second geographical area. The inter-city booking request may include at least a pick-up location associated with the first geographical area, a drop-off location associated with the second geographical area, or a pick-up time from the pick-up location. The transportation server predicts inter-city demands towards the first geographical area from one or more intermediate geographical areas including the second geographical area. The inter-city demands may be predicted based on at least historical travel data, external event information, inter-city ride information corresponding to pre-booked inter-city rides, or a combination thereof, such that each predicted inter-city demand is associated with a pick-up time that is after a completion time of the first ride.

The transportation server determines an actual ride fare for the first ride based on the received inter-city booking request. The transportation server further determines a discounted ride fare for the first ride based on the predicted inter-city demands and the received inter-city booking request. A user interface including at least the actual ride fare and the discounted ride fare is rendered on the passenger device by the transportation server. The transportation server receives a message from the passenger device based on an option selected by the passenger from a plurality of options included on the user interface. In one embodiment, a confirmation message indicating a confirmation of the discounted ride fare is received by the transportation server, when the passenger selects a first option to confirm the inter-city booking request based on the discounted ride fare. In another embodiment, a cancellation message indicating a cancellation of the inter-city booking request is received by the transportation server, when the passenger selects a second option to cancel the inter-city booking request. The transportation server allocates a vehicle to the passenger for the first ride based on the received confirmation message. The vehicle is selected from vehicles based on at least one of preferences of drivers of the vehicles for the inter-city rides, driver ratings of the drivers, or historical travel experiences of the drivers for the inter-city rides.

The transportation server further determines, in the second geographical area, a layover time period based on the completion time of the first ride and a pick-up time of a second ride from one of the one or more intermediate geographical areas. The second ride is an inter-city ride from one of the one or more intermediate geographical areas towards the first geographical area and is determined based on the predicted inter-city demands. When the layover time period is greater than or equal to a defined time period, the transportation server receives intra-city booking requests from passenger devices of passengers associated with the one or more intermediate geographical areas, such as the second geographical area. In one embodiment, the intra-city booking requests may be received before the completion of the first ride. In another embodiment, the intra-city booking requests may be received after the completion of the first ride. The transportation server allocates the vehicle to a passenger from the passengers based on at least an intra-city booking request requested by the passenger and the layover time period.

Thus, the method and the system of the present disclosure effectively and efficiently allocate the vehicle to the passenger for the inter-city ride from the first geographical area to the second geographical area based on the predicted inter-city demands. The passenger may get a higher discount on the inter-city ride, when a probability of a return ride from the one or more intermediate geographical areas is higher (i.e., greater than a threshold value), thereby, minimizing ride fare corresponding to the inter-city ride requested by the passenger, which in turn may help to maximize inter-city bookings. Furthermore, when the passenger chooses for the return ride from the second geographical area to the first geographical area, the discount on the return ride may further be optimized such that the return ride fare is less than or equal to the discounted ride fare associated with the inter-city ride. Thus, the overall ride fare and the ride time associated with a round inter-city trip may be optimized without any discomfort to the passenger, which otherwise may be troublesome for the passenger when the inter-city ride and the corresponding return ride have been booked separately. Furthermore, a driver of the vehicle will not end up coming empty from the second geographical area after the completion of the inter-city ride, thereby maximizing the overall earnings of the driver during the inter-city trip and minimizing wastage of fuels, such as petrol, diesel, or compressed natural gas (CNG). Furthermore, when the layover time period in the second geographical area is greater than the defined time period, the vehicle may be allocated to other passengers of the second geographical area corresponding to the intra-city rides requested by the passengers. Thus, the overall earnings of the driver may further increase and ensure efficient utilization of the vehicle during such inter-city trips.

### BRIEF DESCRIPTION OF DRAWINGS

The accompanying drawings illustrate the various embodiments of systems, methods, and other aspects of the disclosure. It will be apparent to a person skilled in the art that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa.

FIG. 1 is a block diagram that illustrates an environment in which various embodiments of the present disclosure are practiced;

FIG. 2 is a block diagram that illustrates a transportation server of the environment of FIG. 1, in accordance with an exemplary embodiment of the present disclosure;

FIG. 3 is a block diagram that illustrates inter-city rides between geographical areas, in accordance with an exemplary embodiment of the present disclosure;

FIG. 4 is a block diagram that illustrates a user interface rendered on a passenger device of the environment of FIG. 1, in accordance with an exemplary embodiment of the present disclosure;

FIGS. 5A and 5B, collectively, illustrates a flow chart of a method for optimizing inter-city rides, in accordance with an exemplary embodiment of the present disclosure; and

FIG. 6 is a block diagram that illustrates a computer system for optimizing inter-city rides, in accordance with an exemplary embodiment of the present disclosure.

### DETAILED DESCRIPTION

As used in the specification and claims, the singular forms “a”, “an” and “the” may also include plural references. For example, the term “an article” may include a plurality of articles. Those with ordinary skill in the art will appreciate that the elements in the Figures are illustrated for simplicity and clarity and are not necessarily drawn to scale. For example, the dimensions of some of the elements in the Figures may be exaggerated, relative to other elements, in order to improve the understanding of the present disclosure. There may be additional components described in the foregoing application that are not depicted on one of the described drawings. In the event such a component is described, but not depicted in a drawing, the absence of such a drawing should not be considered as an omission of such design from the specification.

Before describing the present disclosure in detail, it should be observed that the present disclosure utilizes a combination of system components, which constitutes a system for optimizing inter-city rides. Accordingly, the components and the method steps have been represented, showing only specific details that are pertinent for an understanding of the present disclosure so as not to obscure the disclosure with details that will be readily apparent to those with ordinary skill in the art having the benefit of the description herein. As required, detailed embodiments of the present disclosure are disclosed herein; however, it is to be understood that the disclosed embodiments are merely exemplary of the disclosure, which can be embodied in various forms. Therefore, specific structural and functional details disclosed herein are not to be interpreted as limiting, but merely as a basis for the claims and as a representative basis for teaching one skilled in the art to variously employ the present disclosure in virtually any appropriately detailed structure. Further, the terms and phrases used herein are not intended to be limiting but rather to provide an understandable description of the disclosure.

References to “one embodiment”, “an embodiment”, “another embodiment”, “yet another embodiment”, “one example”, “an example”, “another example”, “yet another example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

### Terms Description (in Addition to Plain and Dictionary Meaning)

Vehicle is a means of transport that is deployed by a vehicle transit system, such as a vehicle service provider, to provide vehicle services, for example, for transporting passengers from one location to another location. The vehicle is an automobile, a bus, a car, a bike, a truck, or the like.

Passenger is a living entity who wants to travel from one location point to another location point, either in the same city or across cities.

Inter-city ride is a journey taken by a passenger using a vehicle to travel from one city to another city, for example, Mumbai to Pune.

Inter-city booking request is a request initiated by a passenger for booking a vehicle for an inter-city ride for travelling from one city to another city. In one example, the passenger may initiate the inter-city booking request by way of a service application or website facilitated or hosted by a vehicle service provider. In another example, the passenger may initiate the inter-city booking request by way of a phone call or a text message on a fixed number associated with the vehicle service provider.

Intra-city ride is a journey taken by a passenger using a vehicle to travel from one location to another location in the same city, for example, Mulund west, Mumbai to Powai lake, Mumbai.

Intra-city booking request is a request initiated by a passenger for booking a vehicle for an intra-city ride. In one example, the passenger may initiate the intra-city booking request by way of a service application or website facilitated or hosted by a vehicle service provider. In another example, the passenger may initiate the intra-city booking request by way of a phone call or a text message on a fixed number associated with the vehicle service provider.

Ride fare is a cost for a ride (for example, an inter-city or intra-city ride) that is paid by a passenger in exchange of a vehicle service availed by the passenger using a vehicle. The cost for the ride is paid to an entity, for example, a driver of the vehicle or a vehicle service provider who has offered the vehicle to the passenger for the ride in an online manner. The ride fare may be paid by the passenger to the entity before or after the completion of the ride. Further, the ride fare may be paid by the passenger in an offline or online manner.

Layover time period is a time period between a completion time of an inter-city ride and a start time of a next inter-city ride.

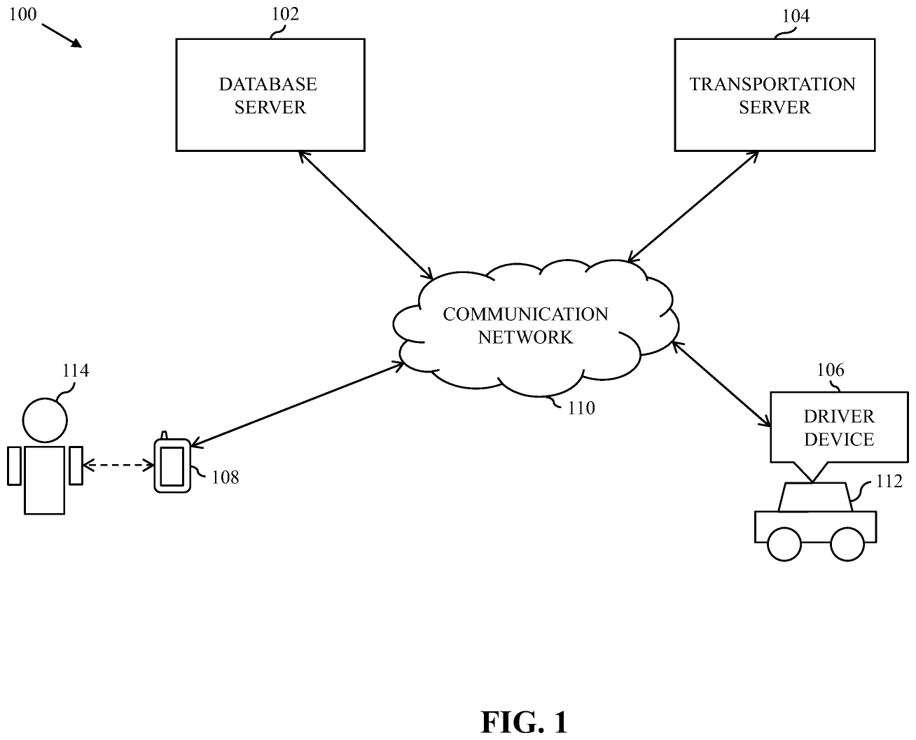

Referring now to FIG. 1, a block diagram that illustrates an environment 100 in which various embodiments of the present disclosure are practiced. The environment 100 includes a database server 102, a transportation server 104, a driver device 106, and a passenger device 108 that communicate with each other by way of a communication network 110. The driver device 106 is associated with a vehicle 112. The driver device 106 and the vehicle 112 are further associated with a driver (not shown). The passenger device 108 is associated with a passenger 114. The environment 100 shows, for simplicity, one passenger device, i.e., the passenger device 108, and one driver device i.e., the driver device 106. However, it will be apparent to a person having ordinary skill in the art that the disclosed embodiments may be implemented with multiple passenger devices and multiple driver devices, without departing from the scope of the disclosure.

The database server 102 may include suitable logic, circuitry, interfaces, and/or code, executable by the circuitry, that may be configured to perform one or more database operations, such as receiving, storing, processing, and transmitting queries, data, or content. The database server 102 is a data management and storage server that performs the one or more database operations, such as receiving, storing, processing, and transmitting queries, data, or content, such as passenger data, driver data, vehicle data, booking data, allocation data, or the like. The queries, data, or content may be received/transmitted from/to various components of the environment 100, such as the transportation server 104, the driver device 106, or the passenger device 108. The database server 102 includes the circuitry for managing and storing historical travel data of one or more passengers or drivers (hereinafter, passengers or drivers), including that of geographical areas, for example, first and second geographical areas. The historical travel data may include historical inter-city or intra-city booking requests and corresponding allocation information associated with the geographical areas. For example, a historical inter-city booking request may include historical inter-city ride information, such as a historical pick-up location in one geographical area (e.g., Bengaluru) and a corresponding historical drop-off location in another geographical area (e.g., Pune). In one example, each historical pick-up and drop-off location may be represented by latitude and longitude coordinates. The historical inter-city booking request may further include a time stamp that indicates a time instant at which the inter-city booking request was initiated by a corresponding passenger. Similarly, a historical intra-city booking request may include intra-city ride information, such as historical pick-up and drop-off locations associated with the same geographical area (e.g., Bengaluru).

The database server 102 further stores inter-city or intra-city ride information associated with inter-city or intra-city rides that have been pre-booked by the passengers in advance. The inter-city or intra-city ride information may include at least one of a pick-up location, a drop-off location, a pick-up time, a vehicle type, or the like. The database server 102 further stores driver information of the drivers associated with one or more vehicles (hereinafter, vehicles), such as the vehicle 112. The driver information of each driver includes at least a name, a contact number, a home location, a license identifier (ID), a vehicle registration ID, or the like. The driver information may further include preferences, ratings, and historical travel experiences of each driver. The driver preferences of each driver may indicate preferences of each driver for driving between two or more geographical areas, for example, from a first city to a second city, from the second city to a third city, from the third city to the first city, or the like.

The database server 102 further stores event information of one or more upcoming events (hereinafter, events) associated with each geographical area. The event information includes information pertaining to the events, such as festivals, concerts, gatherings, sports, or the like, in and around the various geographical areas. Further, in an embodiment, the database server 102 receives a query from the transportation server 104 to retrieve the historical travel data, the inter-city or intra-city ride information, the driver information, or the like. The database server 102, in response to the received query from the transportation server 104, retrieves and transmits the requested information to the transportation server 104 over the communication network 110. Examples of the database server 102 include, but are not limited to, a personal computer, a laptop, or a network of computer systems.

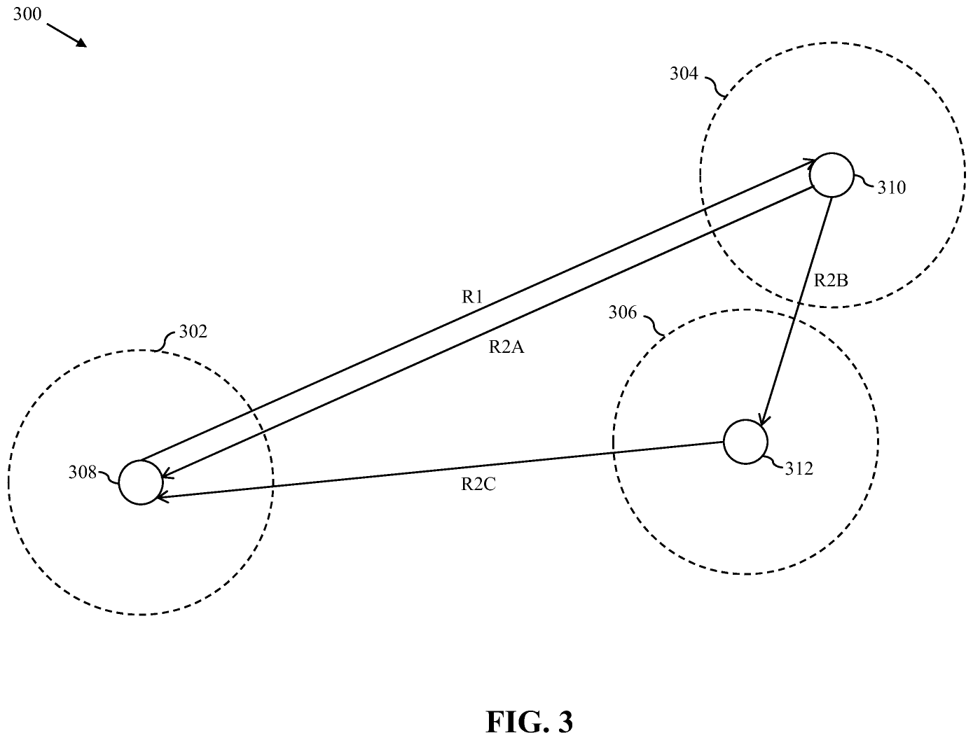

The transportation server 104 may include suitable logic, circuitry, interfaces, and/or code, executable by the circuitry, that may be configured to perform one or more operations for optimizing allocation of the vehicles (such as the vehicle 112) to the passengers (such as the passenger 114). The transportation server 104 may be a computing device, which may include a software framework, that may be configured to create the transportation server implementation and perform the various operations associated with the allocation of the vehicles. In an embodiment, the various operations of the transportation server 104 may be dedicated to execution of procedures, such as, but are not limited to, programs, routines, or scripts stored in a memory for supporting its applied applications. In an embodiment, the transportation server 104 receives an inter-city booking request for a first ride from the passenger device 108. The first ride is an inter-city ride for travelling from the first geographical area to the second geographical area, for example, from a first city (e.g., Mumbai) to a second city (e.g., Pune). The transportation server 104 retrieves at least one of the historical travel data, the event information of the external events, or inter-city ride information corresponding to the pre-booked inter-city rides from the database server 102, and predicts one or more inter-city demands (hereinafter, inter-city demands). For example, the transportation server 104 predicts the inter-city demands towards the first geographical area from one or more intermediate geographical areas (hereinafter, intermediate geographical areas). In one embodiment, the intermediate geographical areas include the second geographical area associated with the drop-off location of the received inter-city booking request. In another embodiment, the intermediate geographical areas include other geographical areas that are along a direction of the first geographical area from the second geographical area. In an exemplary scenario, the predicted inter-city demands may include an inter-city demand corresponding to a second ride, for example, an inter-city ride from the second geographical area to the first geographical area. Various exemplary scenarios of the predicted inter-city demands have been described in detail in conjunction with FIG. 3.

In an embodiment, the transportation server 104 further determines actual and discounted ride fares for the first ride. The actual ride fare may be determined based on at least the received inter-city booking request. The discounted ride fare may be determined based on at least the received inter-city booking request and the predicted inter-city demands. The transportation server 104 further renders a user interface on the passenger device 108 including at least the actual and discounted ride fares. Based on a confirmation of one of the actual or discounted ride fare by the passenger 114, the transportation server 104 allocates a vehicle, for example, the vehicle 112 to the passenger 114 for the first ride from the first geographical area to the second geographical area. The transportation server 104 further transmits allocation information associated with the inter-city booking request to at least one of the driver device 106 or the passenger device 108. Based on the allocation information, the driver of the vehicle 112 may identify the pick-up location and time associated with the inter-city booking request. Thereafter, the driver may drive the vehicle 112 to reach the pick-up location of the passenger 114 in accordance with the pick-up time and pick-up the passenger 114 for the first ride. In one example, the driver may utilize a digital map (hosted by the transportation server 104) on the driver device 106 to navigate between locations, for example, from a current location to the pick-up location. Further, based on the allocation information, the passenger 114 may track real-time position of the vehicle 112. For example, the passenger 114 may utilize a digital map (hosted by the transportation server 104) on the passenger device 108 to track the real-time position of the vehicle 112.

In an embodiment, the transportation server 104 may predict a ride completion time of the first ride based on the inter-city booking request, for example, using the pick-up time and a total ride time duration associated with the first ride. In one example, the total ride time duration of the first ride may be determined based on at least a distance and traffic conditions between the pick-up location in the first geographical area and the drop-off location in the second geographical area. An average speed of the vehicle 112 may also be utilized to determine the total ride time duration of the first ride. The transportation server 104 further determines a layover time period for the vehicle 112 in the second geographical area based on the ride completion time of the first ride and the predicted inter-city demands.

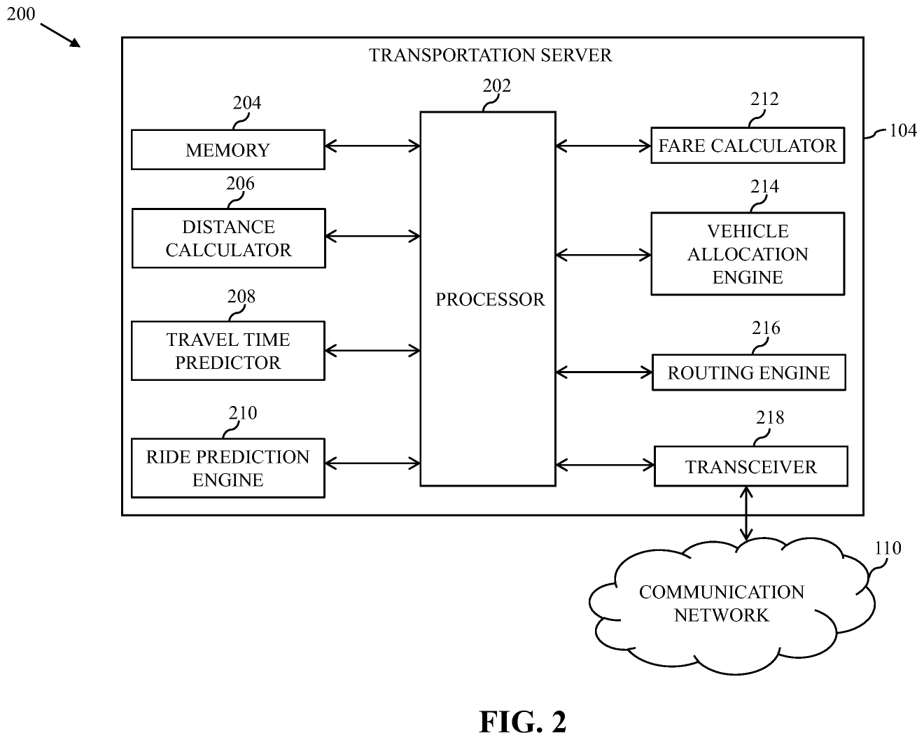

In an embodiment, the transportation server 104 may receive one or more intra-city booking requests (hereinafter, intra-city booking requests) from passenger devices of the passengers associated with the intermediate geographical areas, for example, the second geographical area, when the layover time period is greater than or equal to a defined time period, for example, 5 hours. The transportation server 104 may allocate the vehicle 112 to one of the passengers for providing vehicle services based on at least an intra-city booking request requested by one of the passengers and the layover time period. The transportation server 104 may be realized through various web-based technologies such as, but not limited to, a Java web-framework, a .NET framework, a PHP framework, or any other web-application framework. Examples of the transportation server 104 include, but are not limited to, a personal computer, a laptop, or a network of computer systems. The elements of the transportation server 104 along with their operations have been described in detail in conjunction with FIG. 2.

It will be apparent to a person having ordinary skill in the art that the scope of the disclosure is not limited to realizing the database server 102 and the transportation server 104 as separate entities. In an embodiment, the functionalities of the database server 102 can be integrated into the transportation server 104, without departing from the spirit of the disclosure. Further, in an embodiment, the transportation server 104 may be realized as an application program installed on and/or running on the driver device 106 and/or the passenger device 108, without departing from the spirit of the disclosure.

The driver device 106 may include suitable logic, circuitry, interfaces, and/or code, executable by the circuitry, that may be configured to perform one or more operations associated with various ride services. The driver device 106 may be a computing device that is installed, either permanently or temporarily, within the vehicle 112. The vehicle 112 is a means of transport, for example, a car that is deployed by a vehicle service provider to provide vehicle services to the passengers such as the passenger 114. The driver device 106 may be associated with the driver of the vehicle 112. In an embodiment, the driver device 106 may include one or more position-tracking sensors for tracking position information of the driver device 106 by way of a navigation system, such as a global positioning system (GPS), which in turn may indicate position information of the vehicle 112. The driver device 106 automatically transmits the position information of the vehicle 112 to the transportation server 104 by means of a driver service application that runs on the driver device 106. In other way round, the driver service application may be configured to extract the position information of the vehicle 112 from one or more position-tracking sensors of the vehicle 112 and communicate the extracted position information to the transportation server 104 over the communication network 110.

In an embodiment, the driver device 106 may receive the allocation information associated with the inter-city or intra-city rides from the transportation server 104. The driver device 106 may receive the allocation information by means of the driver service application running on the driver device 106. The driver service application presents the allocation notification to the driver of the vehicle 112. The driver uses the allocation information to identify the pick-up location and time associated with the allocated ride (e.g., an inter-city or intra-city ride), and thereafter, the driver drives the vehicle 112 to reach the pick-up location of the allocated ride in accordance with the pick-up time. The driver may follow one or more routes on the digital map presented by the transportation server 104 on the driver device 106 for reaching the pick-up location. The driver of the vehicle 112 may further use the driver service application to cancel the allocated ride, when the driver is not in a position to complete the allocated ride, either due to personal or professional constraints. In one example, the driver device 106 is a vehicle head unit of the vehicle 112. In another example, the driver device 106 is an external communication device associated with the driver, such as a mobile phone, a smartphone, a tablet, a phablet, or any other portable communication device, which is placed inside the vehicle 112.

The passenger device 108 may include suitable logic, circuitry, interfaces, and/or code, executable by the circuitry, that may be configured to perform one or more operations for availing various ride services offered by the vehicle service provider in an online manner. The passenger device 108 may be a computing device that is used by the passenger 114 to perform one or more activities by means of a passenger service application installed on the passenger device 108. For example, the passenger 114 uses the passenger service application to initiate one or more booking requests for one or more rides, such as the inter-city booking request for the first ride. For initiating the inter-city booking request, the passenger 114 inputs inter-city ride information, such as the pick-up location in the first geographical area, the drop-off location in the second geographical area, the pick-up time, or the like, by means of the passenger service application. The passenger device 108 further transmits the inter-city booking request to the transportation server 104 by means of the passenger service application over the communication network 110. The passenger device 108 further displays the user interface (rendered by the transportation server 104) presenting at least the actual and discounted ride fairs for the first ride. The user interface may further include one or more options, such a first, second, or third option. The first option is selectable by the passenger 114 to confirm the inter-city booking request. The second option is selectable by the passenger 114 to cancel the inter-city booking request. The third option is selectable by the passenger 114 to confirm the second ride from the second geographical area to the first geographical area.

The passenger device 108 further receives the allocation information corresponding to the inter-city booking request from the transportation server 104, for example, by means of the passenger service application. The passenger 114 uses the allocation information to track the real-time position of the vehicle 112, and accordingly reach the pick-up location for the first ride. Examples of the passenger device 108 include, but are not limited to, a mobile phone, a smartphone, a tablet, a phablet, a laptop, or any other portable communication device.

The communication network 110 is a medium through which content and messages are transmitted between various devices or servers, such as the database server 102, the transportation server 104, the driver device 106, and the passenger device 108. Examples of the communication network 110 include, but are not limited to, a wireless fidelity (Wi-Fi) network, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, a mobile network such as cellular data, high speed packet access (HSPA), or any combination thereof. Various devices in the environment 100 may connect to the communication network 110 in accordance with various wired and wireless communication protocols, such as Transmission Control Protocol and Internet Protocol (TCP/IP), User Datagram Protocol (UDP), Long Term Evolution (LTE) communication protocols, or any combination thereof.

Referring now to FIG. 2, a block diagram 200 that illustrates the transportation server 104, in accordance with an exemplary embodiment of the present disclosure, is shown. The transportation server 104 includes a processor 202, a memory 204, a distance calculator 206, a travel time predictor 208, a ride prediction engine 210, a fare calculator 212, a vehicle allocation engine 214, a routing engine 216, and a transceiver 218.

The processor 202 includes suitable logic, circuitry, and/or interfaces that are operable to execute instructions, programs, codes, and/or scripts stored in the memory 204 to perform one or more operations. In an embodiment, the processor 202 receives the one or more booking requests, for example, the inter-city booking request for the first ride for traveling from the first geographical area to the second geographical area, from the passenger device 108 of the passenger 114 by way of the transceiver 218 over the communication network 110. The processor 202 stores the inter-city booking request in the memory 204.

The processor 202 determines booking information including at least the pick-up and drop-off locations of the passenger 114 for the first ride based on the inter-city booking request initiated by the passenger 114 and provides the booking information to the distance calculator 206. The processor 202 further receives distance information including at least a total distance associated with the first ride from the distance calculator 206 and stores the distance information in the memory 204.

The processor 202 further determines the pick-up time for the first ride. In one example, the pick-up time for the first ride is the same as the pick-up time specified by the passenger 114. In another example, the pick-up time is determined based on at least the availability of the vehicles and distance of each available vehicle from the pick-up location of the passenger 114. The processor 202 provides the pick-up time along with the pick-up and drop-off locations of the passenger 114 to the travel time predictor 208. The processor 202 receives a ride completion time for the first ride from the travel time predictor 208 and stores the ride completion time in the memory 204.

The processor 202 further transmits the query to the database server 102 to retrieve at least one of the historical travel data, the event information, or the inter-city ride information associated with the geographical areas, such as the first or second geographical area, from the database server 102. After retrieving the requisite information, the processor 202 provides at least one of the historical travel data, the event information, or the inter-city ride information along with the ride completion time of the first ride to the ride prediction engine 210. The processor 202 receives the inter-city demands predicted by the ride prediction engine 210 and stores the predicted inter-city demands in the memory 204. Each predicted inter-city demand is associated with a probability that indicates a likelihood (or a percentage) of conversion of the predicted demand into a booking supply for transporting the potential passengers. The processor 202 further provides the predicted inter-city demands and the distance of the first ride to the fare calculator 212 and receives the actual and discounted ride fares for the first ride. The processor 202 renders the user interface on the passenger device 108 by means of the passenger service application. The user interface includes at least the actual and discounted ride fares determined for the first ride along with the one or more options that are selectable by the passenger 114.

The processor 202 receives a confirmation message, corresponding to the confirmation of the discounted ride fare by the passenger 114, from the passenger device 108. The processor 202 transmits at least the confirmation message along with the inter-city booking request to the vehicle allocation engine 214 and receives the allocation information associated with the allocated vehicle (such as the vehicle 112) and the driver information of the driver associated with the vehicle 112, and stores the allocation and driver information in the memory 204.

The processor 202 provides the booking information including at least the pick-up and drop-off locations of the passenger 114 to the routing engine 216. The processor 202 receives routing information for the first ride from the routing engine 216 and stores the routing information in the memory 204. The processor 202 transmits the allocation information including the routing information to at least one of the driver device 106 or the passenger device 108 by way of the transceiver 218 over the communication network 110.

The processor 202 further provides the ride completion time of the first ride and the predicted inter-city demands along with their pick-up times to the travel time predictor 208. In response, the processor 202 receives the layover time period, and stores the layover time period in the memory 204. The layover time period is the time period after the completion of the first ride and before the start of the next ride (e.g., the second ride) from one of the intermediate geographical areas such as the second geographical area. When the layover time period is greater than the defined time period, the processor 202 may be configured to receive the intra-city booking requests from the passenger devices of the passengers associated with the intermediate geographical areas such as the second geographical area. The intra-city booking requests are received for the vehicle 112 such that their pick-up times are after the ride completion time of the first ride and drop-off times are before the start of the second ride. The vehicle 112 is allocated to at least one of the passengers who have initiated the intra-city requests such that the vehicle 112 reaches the pick-up location of the second ride at or before the pick-up time of the second ride without any delay.

Examples of the processor 202 include, but are not limited to, an application-specific integrated circuit (ASIC) processor, a reduced instruction set computing (RISC) processor, a complex instruction set computing (CISC) processor, or a field-programmable gate array (FPGA). It will be apparent to a person skilled in the art that the processor 202 is compatible with multiple operating systems.

The memory 204 includes suitable logic, circuitry, and/or interfaces to store one or more sets of instructions, programs, codes, and/or scripts that are executed by the processor 202, the distance calculator 206, the travel time predictor 208, the ride prediction engine 210, the fare calculator 212, the vehicle allocation engine 214, the routing engine 216, and the transceiver 218 to perform their dedicated operations. The memory 204 further stores the inter-city or intra-city booking requests, the booking information, the allocation information, the passenger information, the driver information, the vehicle information, or the like. Examples of the memory 204 include, but are not limited to, a random-access memory (RAM), a read-only memory (ROM), a programmable ROM (PROM), an erasable PROM (EPROM), a hard disk drive (HDD), a secure digital (SD) card, and the like.

The distance calculator 206 includes suitable logic, circuitry, interfaces, and/or code that may be operable to execute instructions, codes, scripts, and/or programs stored in the memory 204. The distance calculator 206 receives the booking information including the pick-up and drop-off locations of the passenger 114, and determines the total distance for the inter-city ride (i.e., the first ride) based on the booking information. The distance calculator 206 provides the distance information including the total distance associated with the first ride to the processor 202. The distance calculator 206 may be realized by use of one or more mathematical models, one or more statistical models, one or more algorithms, or a combination thereof. Further, the distance calculator 206 may be implemented using an ASIC processor, a RISC processor, a CISC processor, an FPGA, or a combination thereof.

The travel time predictor 208 includes suitable logic, circuitry, interfaces, and/or code that may be operable to execute instructions, codes, scripts, and/or programs stored in the memory 204. The travel time predictor 208 receives the pick-up time along with the pick-up and drop-off locations of the passenger 114 from the processor 202, and predicts the ride completion time for the first ride. The travel time predictor 208 predicts the ride completion time of the inter-city booking request based on at least the pick-up time, the total distance and the traffic conditions between the pick-up and drop-off locations, a speed of the vehicle 112, or any combination thereof. The speed of the vehicle 112 may be determined based on an average of historical speeds associated with the vehicle 112. The historical speeds, in case of inter-city rides, are associated with historical inter-city rides. The historical speeds, in case of intra-city rides, are associated with historical intra-city rides. The travel time predictor 208 may be realized by use of one or more mathematical models, one or more statistical models, one or more algorithms, or a combination thereof. Further, the travel time predictor 208 may be implemented using an ASIC processor, a RISC processor, a CISC processor, an FPGA, or a combination thereof.

The ride prediction engine 210 includes suitable logic, circuitry, interfaces, and/or code that may be operable to execute instructions, codes, scripts, and/or programs stored in the memory 204. The ride prediction engine 210 receives at least one of the historical travel data, the event information, and the inter-city ride information associated with the pre-booked inter-city rides, along with the ride completion time of the first ride from the processor 202, and predicts the inter-city demands from the intermediate geographical locations. Each inter-city demand is predicted such that the pick-up time is after the ride completion time of the first ride. The ride prediction engine 210 provides the predicted inter-city demands to the processor 202. The ride prediction engine 210 may be realized by use of one or more mathematical models, one or more statistical models, one or more algorithms, or a combination thereof. Further, the ride prediction engine 210 may be implemented using an ASIC processor, a RISC processor, a CISC processor, an FPGA, or a combination thereof.

The fare calculator 212 includes suitable logic, circuitry, interfaces, and/or code that may be operable to execute instructions, codes, scripts, and/or programs stored in the memory 204. The fare calculator 212 receives the total distance of the first ride and the predicted inter-city demands from the processor 202. The fare calculator 212 determines the actual ride fare for the first ride based on at least one of the total distance and the ride completion time associated with the first ride. The fare calculator 212 further uses a fixed rate card to determine the actual ride fare for the first ride. The rate card may be based on one or more ride parameters, such as a distance parameter, a time parameter, or a combination thereof, for example, a ride fare per unit of distance or a ride fare per unit of travel time. The fare calculator 212 further determines the discounted ride fare for the first ride based on at least one of the total distance and the ride completion time associated with the first ride along with the predicted inter-city demands. For example, firstly, the actual ride fare is determined as described above. Thereafter, a discount for the first ride is determined based on the predicted inter-city demands. For example, the discount for the first ride may be higher, when a probability of a return ride from the intermediate geographical areas, such as the second geographical area, is higher (i.e., greater than a threshold value). The fare calculator 212 may be realized by use of one or more mathematical models, one or more statistical models, one or more algorithms, or a combination thereof. Further, the fare calculator 212 may be implemented using an ASIC processor, a RISC processor, a CISC processor, an FPGA, or a combination thereof.

The vehicle allocation engine 214 includes suitable logic, circuitry, interfaces, and/or code that may be operable to execute instructions, codes, scripts, and/or programs stored in the memory 204. The vehicle allocation engine 214 allocates a vehicle, such as the vehicle 112, to the passenger 114 for the first ride based on the confirmation message indicating at least the confirmation of the discounted ride fare by the passenger 114. The vehicle allocation engine 214 further provides the allocation information along with the driver information of the driver associated with the vehicle 112 to the processor 202. The vehicle allocation engine 214 may also allocate the vehicle 112 to other passengers for the intra-city rides in the intermediate geographical areas, such as the second geographical area, after the completion of the first ride. The vehicle allocation engine 214 may be realized by use of one or more mathematical models, one or more statistical models, one or more algorithms, or a combination thereof. Further, the vehicle allocation engine 214 may be implemented using an ASIC processor, a RISC processor, a CISC processor, an FPGA, or a combination thereof.

The routing engine 216 includes suitable logic, circuitry, interfaces, and/or code that may be operable to execute instructions, codes, scripts, and/or programs stored in the memory 204. The routing engine 216 receives the booking information including the pick-up and drop-off locations of the passenger 114 from the processor 202, and determines the routing information for the first ride. The routing information includes at least one route between the pick-up and drop-off locations along which the driver may drive the vehicle 112 to transport the passenger 114 from the pick-up location in the first geographical area to the drop-off location in the second geographical area. The routing engine 216 may further determine the routing information for the intra-city rides in the intermediate geographical areas, such as the second geographical area, after the completion of the first ride. The routing engine 216 may include the routing information on the digital map that may provide navigational assistance to the driver or the passenger 114 while navigating between locations. The routing engine 216 may be realized by use of one or more mathematical models, one or more statistical models, one or more algorithms, or a combination thereof. Further, the routing engine 216 may be implemented using an ASIC processor, a RISC processor, a CISC processor, an FPGA, or a combination thereof.

The distance calculator 206, the travel time predictor 208, the ride prediction engine 210, the fare calculator 212, the vehicle allocation engine 214, and the routing engine 216 have been shown and described as separate entities in FIG. 2. However, a person having ordinary skill in the art will appreciate that the distance calculator 206, the travel time predictor 208, the ride prediction engine 210, the fare calculator 212, the vehicle allocation engine 214, and the routing engine 216 may be implemented by means of a single processor, such as the processor 202, without departing from the scope of the disclosure. Thus, in such a scenario, the processor 202 may be configured to perform the various operations of the distance calculator 206, the travel time predictor 208, the ride prediction engine 210, the fare calculator 212, the vehicle allocation engine 214, and the routing engine 216, without departing from the spirit of the disclosure.

The transceiver 218 includes suitable logic, circuitry, and/or interfaces to transmit or receive messages from various devices, such as the database server 102, the driver device 106, and the passenger device 108. The transceiver 218 communicates with the database server 102, the driver device 106, and the passenger device 108 over the communication network 110. The transceiver 218 receives the inter-city or intra-city booking requests from the passenger devices of the passengers, such as the passenger device 108 of the passenger 114. Examples of the transceiver 218 include, but are not limited to, an antenna, a radio frequency transceiver, a wireless transceiver, and the like. The transceiver 218 communicates with the database server 102, the driver device 106, and the passenger device 108 using various wired and wireless communication protocols, such as TCP/IP, UDP, or any combination thereof.

Referring now to FIG. 3, a block diagram 300 that illustrates the inter-city rides between the geographical areas, in accordance with an exemplary embodiment of the present disclosure, is shown. In an embodiment, the vehicle service provider (e.g., a cab service provider) operates in the geographical areas, such as first, second, and third geographical areas 302, 304, and 306. The first, second, and third geographical areas 302, 304, and 306 include at least first, second, and third locations 308, 310, and 312, respectively. For simplicity, only three geographical areas, i.e., the first, second, and third geographical areas 302, 304, and 306 have been shown. However, it will be apparent to a person skilled in the art that the vehicle service provider may operate in any number of geographical areas.

In one scenario, a first passenger, for example, the passenger 114 initiates a first inter-city booking request for the first ride for travelling from the first geographical area 302, such as a first city (e.g., Mumbai), to the second geographical area 304, such as a second city (e.g., Pune). For the first ride, the first location 308 is a first pick-up location and the second location 310 is a first drop-off location. The transportation server 104 receives the first inter-city booking request and determines the actual ride fare for the first ride based on the first inter-city booking request. The transportation server 104 further determines a first route R1 from the first geographical area 302 to the second geographical area 304 and the ride completion time for the first ride. The transportation server 104 further predicts an inter-city demand for the second ride from the second geographical area 304 to the first geographical area 302. The inter-city demand is predicted such that the pick-up time for the inter-city demand is after the completion time of the first ride. Based on the prediction, the transportation server 104 determines the discounted ride fare for the first ride. The transportation server 104 further renders the user interface on the passenger device 108 presenting the actual and discounted ride fares for the first ride. The passenger 114 confirms the first inter-city booking request based on the discounted ride fare for the first ride. The transportation server 104 receives the confirmation from the passenger device 108 and allocates the vehicle 112 to the passenger 114 for the first ride. The transportation server 104 further transmits the allocation information to at least one of the passenger device 108 or the driver device 106.

Based on the allocation information, the driver of the vehicle 112 picks up the passenger 114 from the first location 308 for the first ride. The vehicle 112 is driven along the first route R1 by the driver and drops off the passenger 114 at the second location 310 to complete the first ride.

The transportation server 104 determines the layover time period for the vehicle 112 in the second geographical area 304 based on the ride completion time of the first ride and the predicted inter-city demand. The transportation server 104 determines that the layover time period is greater than the defined time period. During the layover time period, the transportation server 104 start receiving the intra-city booking requests associated with the second geographical area 304. The transportation server 104 may allocate the vehicle 112 to the intra-city booking requests during the layover time period, provided that the completion time for the intra-city booking request is before the pick-up time of the predicted inter-city booking request.

The transportation server 104 receives a second inter-city booking request for the second ride for travelling from the second geographical area 304 to the first geographical area 302. In one example, the transportation server 104 receives the second intra-city booking request from the passenger device 108. In another example, the transportation server 104 receives the second intra-city booking request from a second passenger device (not shown) associated with a second passenger (not shown) from the second geographical area 304. In one example, the second location 310 is the pick-up location and the first location 308 is the drop-off location for the second ride. However, without limiting the scope of the disclosure, any other location associated with the second geographical area 304 may be the pick-up location for the second ride. Similarly, any other location associated with the first geographical area 302 may be the drop-off location for the second ride. The transportation server 104 further determines a second route R2 for the second ride. The transportation server 104 allocates the vehicle 112 to the second passenger for the second ride. The method of allocation of the vehicle 112 to the second passenger for the second ride is similar to that of the first ride. The vehicle 112 is driven along the second route R2 by the driver to complete the second ride and the driver of the vehicle 112 returns to the first geographical area 302. Here, when the driver is traveling between the locations, the driver may utilize the digital map (hosted and rendered by the transportation server 104 on the driver device 106) to navigate between the locations, which in turn may facilitate accurate and safe driving between the locations. The utilization of the digital map further helps in saving ride time. By optimizing the ride time, various types of fuels (such as renewable or non-renewable fuels) used in the vehicle 112 may be optimized, which in turn reduces the overall expense incurred by the driver for providing the ride services. This will further help in higher earnings for the driver. Also, the optimization of the various types of fuels during such ride services cause less pollution to the environment in which we all live-in.

In another scenario, the transportation server 104 receives the first inter-city booking request from the passenger device 108 for the first ride from the first geographical area 302 to the second geographical area 304. The transportation server 104 determines the actual ride fare for the first ride based on the first inter-city booking request. The transportation server 104 further determines the first route R1 from the first geographical area 302 to the second geographical area 304 and the completion time for the first ride. The transportation server 104 fails to predict an inter-city demand from the second geographical area 304 to the first geographical area 302. However, the transportation server 104 predicts an inter-city demand from the third geographical area 306 to the first geographical area 302 having a pick-up time after the completion time of the first ride. The transportation server 104 determines the discounted ride fare for the first ride based on the predicted inter-city demand. The transportation server 104 further renders the user interface on the passenger device 108 indicating the actual and discounted ride fares for the first ride. The passenger 114 confirms the first inter-city booking request based on the discounted ride fare for the first ride. The transportation server 104 receives the confirmation from the passenger device 108 and allocates the vehicle 112 to the passenger 114 for the first ride. The transportation server 104 also transmits the allocation information to the passenger device 108 and the driver device 106.

The vehicle 112 is driven along the first route R1 by the driver to complete the first ride from the first geographical area 302 to the second geographical area 304. The transportation server 104 does not receive any inter-city booking requests for travelling from the second geographical area 304 to the first geographical area 302. In one example, the transportation server 104 receives a third inter-city booking request from a third passenger device (not shown) of a third passenger (not shown) for a third ride from the second geographical area 304 to the third geographical area 306 and allocates the vehicle 112 to the third inter-city booking request. The method of allocation of the vehicle 112 to the third passenger for the third ride is similar to that of the first ride. In one example, the second location 310 is the pick-up location and the third location 312 is the drop-off location for the third ride. The transportation server 104 determines a third route R2B for the third ride.

In another example, the transportation server 104 dispatches the vehicle 112 from the second geographical area 304 to the third geographical area 306 without receiving any inter-city booking request. The vehicle 112 is driven along the third route R2B by the driver for the third ride. The transportation server 104 determines a layover time period for the vehicle 112 in the third geographical area 306. If the layover time period is greater than the predefined time period, the transportation server 104 may allocate the vehicle 112 to intra-city booking requests in the third geographical area 306.

The transportation server 104 receives a fourth inter-city booking request from a fourth passenger device (not shown) of a fourth passenger (not shown), for a fourth ride from the third geographical area 306 to the first geographical area 302. In one example, the third location 312 is the pick-up location for the fourth ride and the first location 308 is the drop-off location for the fourth ride. However, any other location associated with the third geographical area 306 may be the pick-up location for the fourth ride. Similarly, any other location associated with the first geographical area 302 may be the drop-off location for the fourth ride. The transportation server 104 further allocates the vehicle 112 to the fourth passenger for the fourth ride. The method of allocation of the vehicle 112 to the fourth passenger for the fourth ride is similar to that of the first and third rides. The transportation server 104 also determines a fourth route R2C for the fourth ride. The vehicle 112 is driven along the fourth route R2C by the driver to complete the fourth ride and the driver of the vehicle 112 returns to the first geographical area 302. It will be apparent to a person skilled in the art that the abovementioned exemplary scenario is for illustrative purpose and should not be construed to limit the scope of the disclosure.

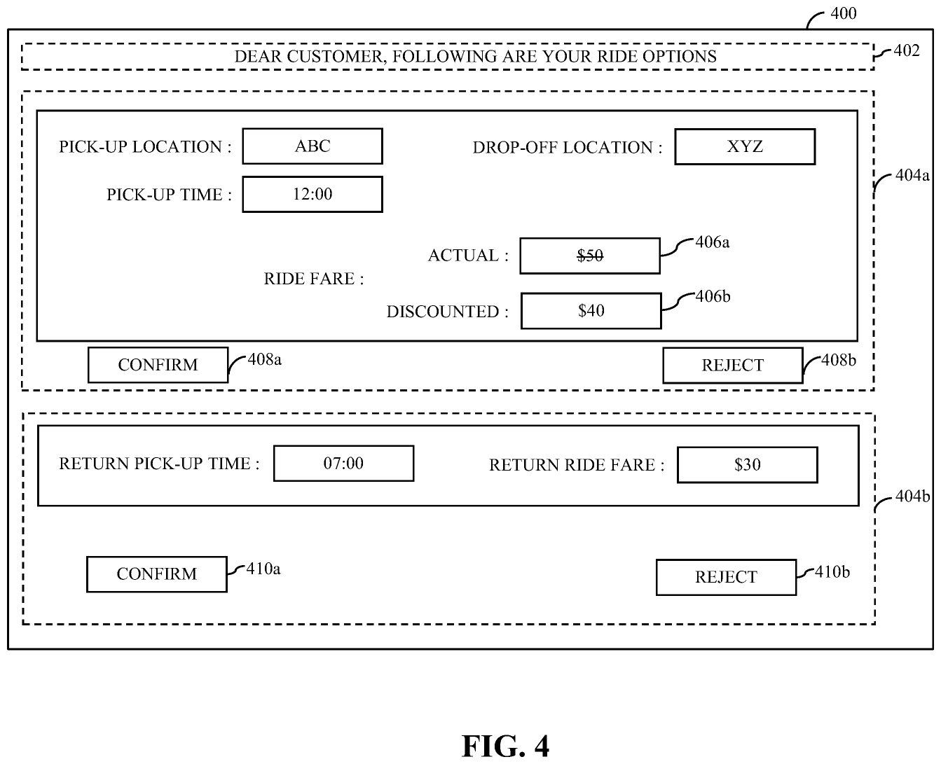

Referring now to FIG. 4, a block diagram that illustrates a user interface 400 rendered on the passenger device 108, in accordance with an exemplary embodiment of the present disclosure, is shown. In one embodiment, the user interface includes one or more sections, such as a message section 402, an inter-city ride information section 404a, and a return ride information section 404b. The message section 402 includes a welcome message, for example, “DEAR CUSTOMER, FOLLOWING ARE YOUR RIDE OPTIONS”, as shown.

The inter-city ride information section 404a indicates the inter-city ride information such as the pick-up location, the drop-off location and the pick-up time of the inter-city booking request. In one example, the inter-city ride information section 404a indicates the inter-city ride information pertaining to the first ride for travelling from the first geographical area to the second geographical area. The inter-city ride information section 404a includes an actual fare section 406a and a discounted fare section 406b that indicate the actual and discounted ride fares of the inter-city ride, respectively. The inter-city ride information section 404a also includes first ‘confirm’ and ‘reject’ tabs 408a and 408b selectable by the passenger 114. The first ‘confirm’ tab 408a provides the passenger 114 with an option to confirm the inter-city booking request. The first ‘reject’ tab 408b provides the passenger 114 with an option to reject the inter-city booking request.

The return ride information section 404b indicates return-ride information such as a return pick-up time and a return ride fare for a return booking request. In one example, the return ride information section 404b indicates information pertaining to the second ride from the second geographical area to the first geographical area. The return ride information section 404b includes second ‘confirm’ and ‘reject’ tabs 410a and 410b selectable by the passenger 114. The second ‘confirm’ tab 410a provides the passenger 114 with an option to confirm the return booking request. The second ‘reject’ tab 410b provides the passenger 114 with an option to reject the return booking request. A person having ordinary skill in the art will understand that the user interface 400 may include multiple sections similar to the inter-city ride information section 404a indicating additional information regarding the inter-city booking request. The passenger 114 inputs a selection to confirm or reject the inter-city booking request based on the discounted ride fare for the first ride by way of the first ‘confirm’ and ‘reject’ tabs 408a and 408b. For example, the passenger 114 may select the first ‘confirm’ tab 408a if the passenger 114 agrees to travel to the second geographical area for the discounted ride fare. The passenger device 108 transmits the selection to the transportation server 104.

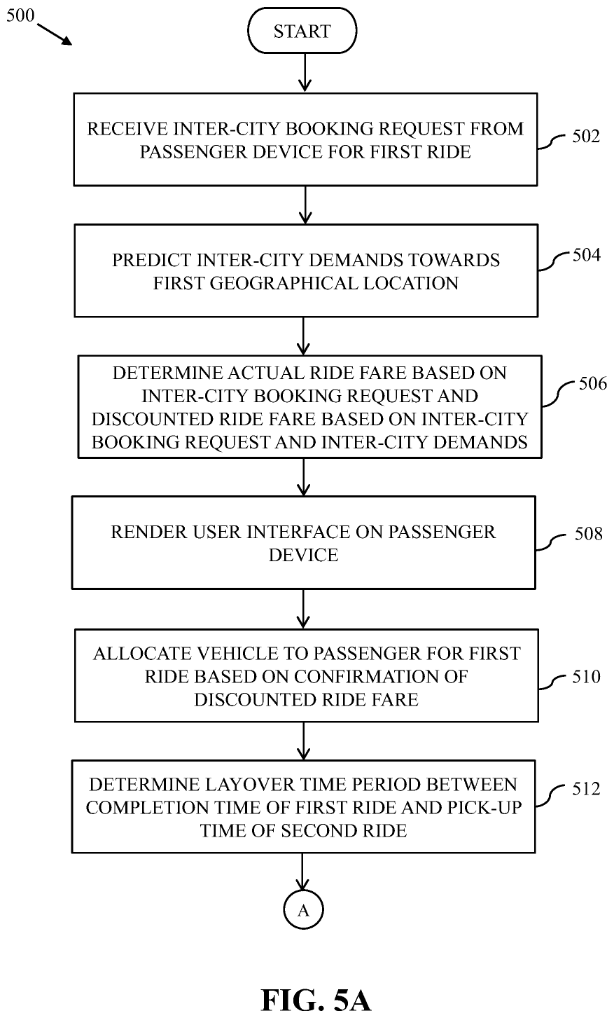

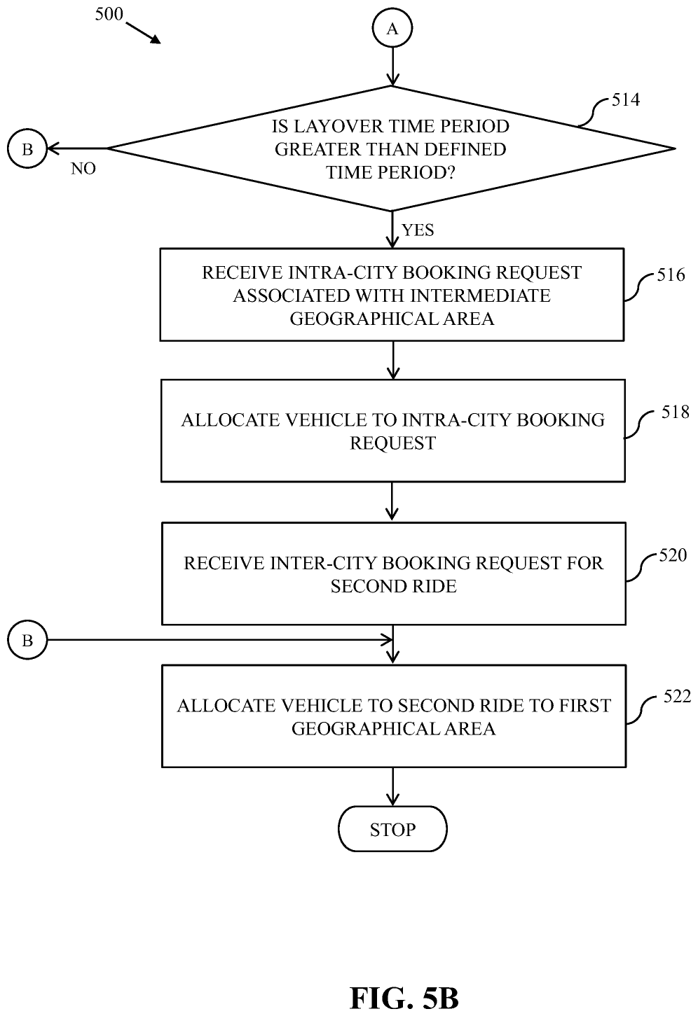

Referring now to FIGS. 5A and 5B, a flow chart 500 that illustrates a method for optimizing inter-city rides, in accordance with an exemplary embodiment of the present disclosure, is shown.

At step 502, the processor 202 receives the inter-city booking request from the passenger device 108 for the first ride from the first geographical area to the second geographical area over the communication network 110 by way of the transceiver 218. At step 504, The ride prediction engine 210 predicts the inter-city demands towards the first geographical area from the intermediate geographical areas, such as the second geographical area based on the historical travel data, the pre-booked inter-city ride information, or the event information. The predicted inter-city demands have pick-up times after the completion time of the first ride. In one example, one of the predicted inter-city demands corresponds to the second ride.

At step 506, the fare calculator 212 determines the actual ride fare for the first ride based on the inter-city booking request and the discounted ride fare for the first ride based on the predicted inter-city booking demands. To determine the discounted ride fare for the first ride, the fare calculator 212 determines the multiplication factor for the actual ride fare based on the predicted inter-city booking demands.

At step 508, the processor 202 renders the user interface on the passenger device 108. The user interface indicates the actual and discounted ride fares for the first ride over the communication network 110. The user interface also indicates the inter-city ride information such as the pick-up and drop-off locations and the pick-up time for the first ride.

At step 510, the vehicle allocation engine 214 allocates the vehicle 112 to the first ride based on the confirmation received from the passenger device 108. Additionally, the vehicle allocation engine 214 allocates the vehicle 112 based on driver information. Further, the processor 202 transmits an allocation notification to the driver device 106 and the passenger device 108 by way of the transceiver 218.

At step 512, the processor 202 determines a layover time period for the vehicle 112 between the completion time of the first ride and the pick-up time of the second ride. At step 514, the processor 202 determines whether the layover time period is greater than or equal to the predefined time period. If at step 514 the processor 202 determines that the layover time period is greater than the predefined time period, step 516 is performed. At step 516, the processor 202 receives the intra-city booking requests associated with an intermediate geographical area by way of the transceiver 218 over the communication network 110. In one example, the processor 202 receives the intra-city booking requests associated with the second geographical area.

At step 518, the vehicle allocation engine 214 allocates the vehicle 112 to the intra-city booking requests. The vehicle allocation engine 214 allocates the vehicle 112 to the intra-city booking requests based on the position of the vehicle 112.

At step 520, the processor 202 receives the inter-city booking request for the second ride to the first geographical area. In one example, the second ride is from the second geographical area to the first geographical area.

If at step 514, the processor 202 determines that the layover time period is less than the predefined time period, step 522 is performed. At step 522, the vehicle allocation engine 214 allocates the vehicle 112 to the second ride. Based on the allocation, processor 202 transmits another allocation notification to the driver device 106 by way of the transceiver 218.

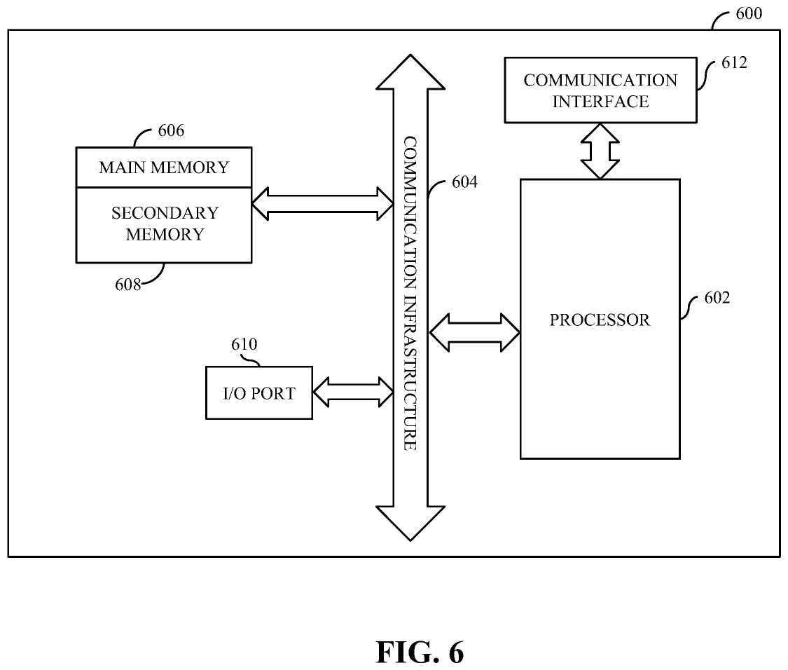

Referring now to FIG. 6, a block diagram of a computer system 600 for optimizing inter-city rides, in accordance with an exemplary embodiment of the present disclosure, is shown. An embodiment of present disclosure, or portions thereof, may be implemented as computer readable code on the computer system 600. In one example, the database server 102, the transportation server 104, the driver device 106, and the passenger device 108 of FIG. 1 may be implemented in the computer system 600 using hardware, software, firmware, non-transitory computer readable media having instructions stored thereon, or a combination thereof and may be implemented in one or more computer systems or other processing systems. Hardware, software, or any combination thereof may embody modules and components used to implement the method of FIGS. 5A and 5B.

The computer system 600 includes a processor 602 that may be a special purpose or a general-purpose processing device. The processor 602 may be a single processor, multiple processors, or combinations thereof. The processor 602 may have one or more processor “cores.” Further, the processor 602 may be connected to a communication infrastructure 604, such as a bus, a bridge, a message queue, the communication network 110, multi-core message-passing scheme, and the like. The computer system 600 further includes a main memory 606 and a secondary memory 608. Examples of the main memory 606 may include RAM, ROM, and the like. The secondary memory 608 may include a hard disk drive or a removable storage drive (not shown), such as a floppy disk drive, a magnetic tape drive, a compact disc, an optical disk drive, a flash memory, and the like. Further, the removable storage drive may read from and/or write to a removable storage device in a manner known in the art. In an embodiment, the removable storage unit may be a non-transitory computer readable recording media.

The computer system 600 further includes an input/output (I/O) port 610 and a communication interface 612. The I/O port 610 includes various input and output devices that are configured to communicate with the processor 602. Examples of the input devices may include a keyboard, a mouse, a joystick, a touchscreen, a microphone, and the like. Examples of the output devices may include a display screen, a speaker, headphones, and the like. The communication interface 612 may be configured to allow data to be transferred between the computer system 600 and various devices that are communicatively coupled to the computer system 600. Examples of the communication interface 612 may include a modem, a network interface, i.e., an Ethernet card, a communications port, and the like. Data transferred via the communication interface 612 may correspond to signals, such as electronic, electromagnetic, optical, or other signals as will be apparent to a person skilled in the art. The signals may travel via a communications channel, which may be configured to transmit the signals to devices that are communicatively coupled to the computer system 600. Examples of the communication channel may include, but are not limited to, cable, fiber optics, a phone line, a cellular phone link, a radio frequency link, a wireless link, and the like.

Computer program medium and computer usable medium may refer to memories, such as the main memory 606 and the secondary memory 608, which may be a semiconductor memory such as dynamic RAMs. These computer program mediums may provide data that enables the computer system 600 to implement the method illustrated in FIGS. 5A and 5B. In an embodiment, the present disclosure is implemented using a computer implemented application, such as the service application of the plurality of passenger device 108. The computer implemented application may be stored in a computer program product and loaded into the computer system 600 using the removable storage drive or the hard disc drive in the secondary memory 608, the I/O port 610, or the communication interface 612.

A person having ordinary skill in the art will appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor such as the processor 602 and a memory such as the main memory 606 and the secondary memory 608 implements the above described embodiments. Further, the operations may be described as a sequential process; however, some of the operations may in fact be performed in parallel, concurrently, and/or in a distributed environment, and with program code stored locally or remotely for access by single or multiprocessor machines. In addition, in some embodiments the order of operations may be rearranged without departing from the spirit of the disclosed subject matter.

The method and system for optimizing inter-city rides provides an efficient utilization of resources such as the vehicles associated with the transportations service provider as well as the fuel required for inter-city rides. The drivers associated with the vehicles are able return to their associated geographical areas while simultaneously completing inter-city booking requests. Thus, the vehicles do not return empty to the corresponding geographical areas after completing the inter-city booking requests in other geographical areas. Moreover, the drivers associated with the transportation service provider are able to earn for return rides to their associated geographical areas. Also, the driver preferences are taken into consideration while allocating the vehicles to the inter-city rides. Thus, drivers may request to be allocated to inter-city rides having drop-off locations close to their associated geographical areas.

The transportation service provider completes additional inter-city booking requests as the drivers return to their associated geographical areas. Thus, the transportation service provider can charge the passengers for one-way rides alone as they travel from one geographical area to another. The passengers, such as the passenger 114 does not have to bear the cost of the return rides while initiating the booking requests. The transportation service provider is able to offer the passengers attractive ride fares for the inter-city rides by offering discounted ride fares. Thus, the demand for inter-city booking requests increases for the transportation service provider due to the availability of discounted ride fares. During the layover time period, the vehicles can complete intra-city ride requests in the intermediate geographical areas. Thus, the drivers are able to earn during the layover time period as well. Additionally, the transportation service provider can specify the multiplication factors for the actual ride fares to determine the discounted ride fares based on business requirements. This provides flexibility for determining the discounted ride fares offered to the passengers.

Techniques consistent with the present disclosure provide, among other features, a method and system for determining transportation service routes for vehicles. Unless stated otherwise, terms such as “first” and “second” are used to arbitrarily distinguish between the elements such terms describe. Thus, these terms are not necessarily intended to indicate temporal or other prioritization of such elements. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for optimizing inter-city rides, the method comprising:
receiving, by circuitry from a passenger device of a passenger over a communication network, an inter-city booking request for a first ride from a first geographical area to a second geographical area;
predicting, by the circuitry, one or more inter-city demands towards the first geographical area from one or more intermediate geographical areas including the second geographical area;
determining, by the circuitry, an actual ride fare and a discounted ride fare for the first ride, wherein the actual ride fare is determined based on the inter-city booking request, and the discounted ride fare is determined based on the inter-city booking request and the one or more inter-city demands;
presenting, by the circuitry, on the passenger device over the communication network, a user interface including at least the actual ride fare and the discounted ride fare; and
allocating, by the circuitry, a vehicle to the passenger for the first ride based on a confirmation of the discounted ride fare by the passenger.

2. The method of claim 1, wherein the inter-city booking request comprises at least a pick-up location associated with the first geographical area, a drop-off location associated with the second geographical area, or a pick-up time from the pick-up location.

3. The method of claim 1, wherein the one or more inter-city demands are predicted based on at least one of historical travel data of the first or second geographical area, one or more external events in the first geographical area, or inter-city ride information corresponding to pre-booked inter-city rides requested by one or more passengers having pick-up locations in the one or more intermediate geographical areas.

4. The method of claim 1, wherein the one or more inter-city demands are predicted such that a pick-up time of each inter-city demand is after a completion time of the first ride.

5. The method of claim 1, further comprising determining, by the circuitry, a layover time period based on a completion time of the first ride and a pick-up time of a second ride, wherein the second ride is an inter-city ride from one of the one or more intermediate geographical areas towards the first geographical area.

6. The method of claim 5, further comprising:
receiving, by the circuitry, one or more intra-city booking requests from one or more passenger devices of one or more passengers associated with the one or more intermediate geographical areas, when the layover time period is greater than or equal to a defined time period; and
allocating, by the circuitry, the vehicle to a passenger from the one or more passengers for providing vehicle services based on at least an intra-city booking request requested by the passenger and the layover time period.

7. The method of claim 1, wherein the user interface further includes a plurality of options including first and second options, wherein the first option is selectable by the passenger to confirm the inter-city booking request based on the discounted ride fare, and the second option is selectable by the passenger to cancel the inter-city booking request.

8. The method of claim 7, wherein the plurality of options further includes a third option for a second ride from the second geographical area to the first geographical area, wherein the third option is selectable by the passenger to confirm the second ride based on a return ride fare for the second ride, wherein the return ride fare is less than or equal to the discounted ride fare for the first ride.

9. The method of claim 1, further comprising selecting, by the circuitry, the vehicle from a plurality of vehicles based on at least one of preferences of drivers for the inter-city rides, driver ratings of the drivers, or historical travel experiences of the drivers for the inter-city rides.

10. A system for optimizing inter-city rides, the system comprising:
circuitry configured to:
receive, from a passenger device of a passenger over a communication network, an inter-city booking request for a first ride from a first geographical area to a second geographical area;
predict one or more inter-city demands towards the first geographical area from one or more intermediate geographical areas including the second geographical area;
determine an actual ride fare and a discounted ride fare for the first ride, wherein the actual ride fare is determined based on the inter-city booking request, and the discounted ride fare is determined based on the inter-city booking request and the one or more inter-city demands;
present, on the passenger device over the communication network, a user interface including at least the actual ride fare and the discounted ride fare; and
allocate a vehicle to the passenger for the first ride based on a confirmation of the discounted ride fare by the passenger.

11. The system of claim 10, wherein the inter-city booking request comprises at least a pick-up location associated with the first geographical area, a drop-off location associated with the second geographical area, or a pick-up time from the pick-up location.

12. The system of claim 10, wherein the one or more inter-city demands are predicted based on at least one of historical travel data of the first or second geographical area, one or more external events in the first geographical area, or inter-city ride information corresponding to pre-booked inter-city rides requested by one or more passengers having pick-up locations in the one or more intermediate geographical areas.

13. The system of claim 10, wherein the one or more inter-city demands are predicted such that a pick-up time of each inter-city demand is after a completion time of the first ride.

14. The system of claim 10, wherein the circuitry is further configured to determine a layover time period based on completion time of the first ride and a pick-up time of a second ride, wherein the second ride is an inter-city ride from one of the one or more intermediate geographical areas towards the first geographical area.

15. The system of claim 14, wherein the circuitry is further configured to:
receive one or more intra-city booking requests from one or more passenger devices of one or more passengers associated with the one or more intermediate geographical areas, when the layover time period is greater than or equal to a defined time period; and
allocate the vehicle to a passenger from the one or more passengers for providing vehicle services based on in at least an intra-city booking request requested by the passenger and the layover time period.

16. The system of claim 10, wherein the user interface further includes a plurality of options including first and second options, wherein the first option is selectable by the passenger to confirm the inter-city booking request based on the discounted ride fare, and the second option is selectable by the passenger to cancel the inter-city booking request.

17. The system of claim 16, wherein the plurality of options further includes a third option for a second ride from the second geographical area to the first geographical area, wherein the third option is selectable by the passenger to confirm the second ride based on a return ride fare for the second ride, wherein the return ride fare is less than or equal to the discounted ride fare for the first ride.

18. The system of claim 10, wherein the circuitry is further configured to select the vehicle from a plurality of vehicles based on at least one of preferences of drivers for the inter-city rides, driver ratings of the drivers, or historical travel experiences of the drivers for the inter-city rides.
